(19) United States
(12) Patent Application Publication
(10) Pub. No.: US 2008/0276046 A1
(43) Pub. Date: Nov. 6, 2008

(54) Architecture for a Multi-Port Cache Memory

(75) Inventors: Cornelis M. Moerman, Eindhoven (NL); Math Verstraelen, Horst (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/916,349

(22) PCT Filed: Jun. 2, 2006
(86) PCT No.: PCT/IB2006/051777

§ 371 Date: Jun. 4, 2008

(30) Foreign Application Priority Data
Jun. 9, 2005 (EP) 05105035.9
Jun. 2, 2006 (IB) PCT/IB2006/051777

(51) Int. Cl. G06F 12/00

(52) U.S. Cl. 711/131; 711/E12.001

(57) ABSTRACT

A multi-port cache memory (200) comprising a plurality of input ports (201, 203) for inputting a plurality of addresses, at least part of each address indexing a plurality of ways; a plurality of output ports (227, 299) for outputting data associated with each of said plurality of addresses; a plurality of memory blocks (219a, 219b, 219c) for storing said plurality of ways, each memory block comprising a single input port (217a, 217b, 217c, 217d) and storing said ways; means (209, 215, 223, 225) for selecting one of said plurality of ways such that data of said selected way is output on an associated output port (227, 229) of said cache memory (200); a predictor (211) for predicting which plurality of ways will be indexed by each of said plurality of addresses; and means (213a, 213b, 213c, 213d) for indexing said plurality of ways based on the predicted ways.

The present invention relates to a multi-port cache memory. In particular, it relates to a way-prediction in an N-way set associative cache memory.

Within current processor technology, caches are a well-known way to decouple processor performance from memory performance (clock speed). To improve cache performance, set associative caches are often utilized. In a set associative cache, a given address selects a set of two or more cache line storage locations which may be used to store the cache line indicated by that address. The cache line storage locations in a set are referred to as the ways of the set, and a cache having N-ways is referred to as an N-way set associative. The required cache line is then selected by means of a tag.

In modern Digital Signal Processors (DSPs), caches are being widely used. However, due to the different architecture of DSPs, having multiple simultaneous interfaces to memory (e.g. one for program instructions, two for data access), cache architectures need to differ from those in classical processor architectures. Invariably, the cache architecture required for a DSP is a dual- or higher-order Harvard memory access architecture. Normally, due to the two transfers per cycle access behavior in dual Harvard, such a cache would be implemented using dual-port memory blocks.

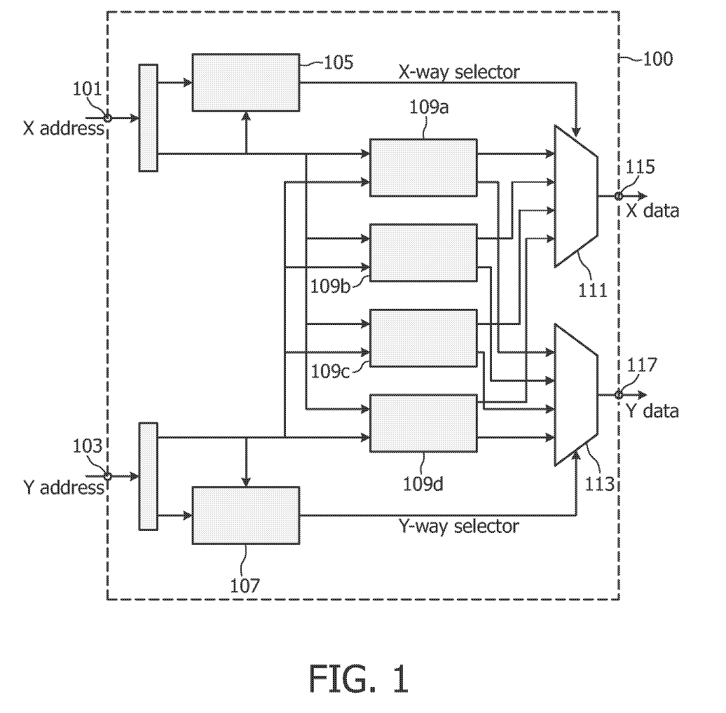

FIG. 1 illustrates a typical N-way set associative cache architecture for a DSP comprising a dual Harvard architecture. The cache memory 100 comprises two input ports 101, 103 connected, for example, to a data bus and an instruction bus (not shown here) requiring simultaneous access to the memory. An address X is input on input port 101 and address Y is input on input port 103 to retrieve the associated data and instruction. Each address X and Y comprises a tag (upper bits) and an index (lower bits). The tag and index of each address X and Y is input into respective tag memories 105, 107 for the first and second input ports 101, 103, respectively. The tag memories 105, 107 output respective X-way selector and Y-way selector following look up of the particular tag. In parallel to the tag memory lookup, each index of the X and Y address is placed on the inputs of a plurality of dual-port memory blocks 109a, 109b, 109c, 109d. Each memory block 109a, 109b, 109c, 109d is accessed by the X-index and Y-index of each X and Y input address to access a plurality of ways. The ways for each address X and Y are output onto respective output ports of each memory block. The plurality of ways accessed by the index of the an X-address are output into an X-way multiplexer 111 and the plurality of ways accessed by the index of the Y-address are output into a Y-way multiplexer 113.

The X-way selector output from the tag memory 105 is input into the X-way multiplexer 111 to select one of the plurality ways accessed by the index of the X address and output from the plurality of dual-ported memory blocks 109a, 109b, 109c and 109d. The data associated with the selected way is placed on a first output port 115 of the cache memory 100. In a similar way, the Y-way is selected by the Y-way multiplexer 113 and the data associated therewith is output on a second output terminal 117 of the cache memory 100.

To enable the simultaneous access required by such known DSPs, dual-port memory blocks are required. However, such dual-ported memory blocks are relatively expensive in terms of area, clock speed and power consumption.

At deep sub-micron technologies, there is a need to keep the memories closely connected to the core, as wiring delays are detrimental in deep sub-micron level due to the increased delay. This is in conflict with the growing memory requirements of modern applications. The conflict can be solved by a cache architecture, where a small cache memory is placed close to the core, buffering accesses to the remote larger memories. This is solved in modern microcontrollers by utilizing one unified memory, interfaced via two memory interfaces, one for program and one for data. However, for DSPs the combination of dual Harvard with caches creates a complication not found in such microcontroller architectures, namely cache coherency between the memory spaces. Due to good separation between code and data in such microcontrollers, not requiring simultaneous accesses to both spaces and allowing independent implementation of data and program caches lack of coherency is not an issue.

On DSPs having two (or more) data buses connecting to the same data memory, a cache architecture has to solve incoherency in a more efficient way due to the more intensive sharing of data over the memory spaces. This is achieved by using a dual-port cache architecture having internally dual-port memory blocks to allow two accesses per cycle as shown in FIG. 1. This makes sure data is only represented in one cache memory block, thereby making sure coherency is guaranteed. However, this has great overhead in area and speed, as dual-port memories are less efficient compared to normal, single-port memories.

As an alternative, instead of parallel access, the tag lookup can be carried out before the actual memory accesses. However this requires an extra memory access to the tag memory 105, 107 before the access of the actual memory blocks 109a-109d. This extra access would have significant impact on the speed and performance of the processor.

Therefore, the present invention overcomes the drawbacks of dual-ported memory blocks and utilize single-ported memory blocks or the like in a dual or multi-port cache memory suitable for a DSP or the like, without requiring an extra cycle to do tag memory access before the actual memory block access.

This is achieved, according to an aspect of the present invention, by providing a multi-port cache memory comprising: a plurality of input ports for inputting a plurality of addresses, at least part of each address indexing a plurality of ways; a plurality of output ports for outputting data associated with each of said plurality of addresses; a plurality of memory blocks for storing said plurality of ways, each said memory block comprising a single input port; a predictor for predicting which plurality of ways will be indexed by each of said plurality of addresses; and means for indexing said plurality of ways based on the predicted ways; and means for selecting one of said plurality of ways such that data of said selected way is output on an associated output port of said cache memory.

In this way, single-ported memory blocks can be utilized in a multi-port cache. This reduces the area of the memory, increases clock speed and reduces power consumption. Since single-ported memory blocks are used, only one access per memory block is allowed per cycle, i.e. two simultaneous accesses must refer to different memory blocks. The memory can be split into multiple smaller blocks. Only one or two smaller blocks are active per cycle which further reduced power consumption.

The use of prediction instead of an actual tag memory lookup enables early selection of the right memory block to be accessed. In the event of a wrong prediction, however, both occurrence and cost of the penalty is limited. In a practical implementation this may be as low as one clock cycle.

Way prediction is effective, as in many cases the application software will not have completely ‘random’ behavior with respect to accesses via the two data channels. Just like data access is more or less structured in time (temporal locality of reference) also the access over the data spaces is structured (form of spatial locality).

Further, in many cases, for two simultaneous accesses, it can be assumed that these will be located in different ‘ways’, and thus if it is known which ‘way’ will be addressed, the address of the memory access can be directed to the right way (and associated memory block) without having conflicts towards that specific way (conflict being two spaces having addresses to the same way).

Preferably, the selecting means comprises a plurality of tag memories for looking up a tag part of each associated address in parallel to indexing of said plurality of ways.

Since the tag memory access is done in parallel, i.e. in the same cycle as the actual way memory accesses, selecting the correct data of all cache way memories only at the end of the access cycle, means address conflicts can be prevented.

Using the fact that there is locality of reference per data space, in its simplest form it can be assumed that the next memory access is likely to access the same way as the previous access. This means prediction in its simplest form can be utilized such as comparing the tag part of the accessed address with the previous address, and using the result to select the most likely combinations of addresses and memory blocks. This is a relative low cost operation not involving e.g. memory accesses. Based on this prediction, the accesses can proceed based on the same way as the previous access. In case of a wrong prediction, one access still can be performed; the other one may need one extra cycle to perform an additional access.

Prediction may be carried out in a number of different ways, for example: the predictor maintains a history of the last n accesses and examines trends in the history to predict the next way or the predictor, per space, uses the last N accesses to predict up to N different ways, wherein N may be equal to the number of address pointers. Alternatively, the predictor may further include means for establishing which address pointer within a set of address pointers is performing the request and predicting the next way on the basis of which address pointer is performing the request.

Alternatively, due to the regular structure of DSP programs, it might be sufficient to only track dual accesses, assuming that single accesses are used differently (e.g. the dual accesses doing the data and coefficient fetch, the single access being a result write) and so do not add in the prediction of conflicting situations. This will reduce the amount of history to keep in the prediction unit compared to the previous optimization.

The multi-port cache memory of the present invention may be incorporated in digital signal processors for many various devices such as, for example, a mobile telephone device or electronic handheld information device (a personal digital assistant, PDA) or laptop or the like.

For a more complete understanding of the present invention, reference is made to the following detailed description taken in conjunction with the accompanying drawings, wherein:

FIG. 1 illustrates a simplified block diagram of a known, N-way set associative cache architecture for a DSP; and

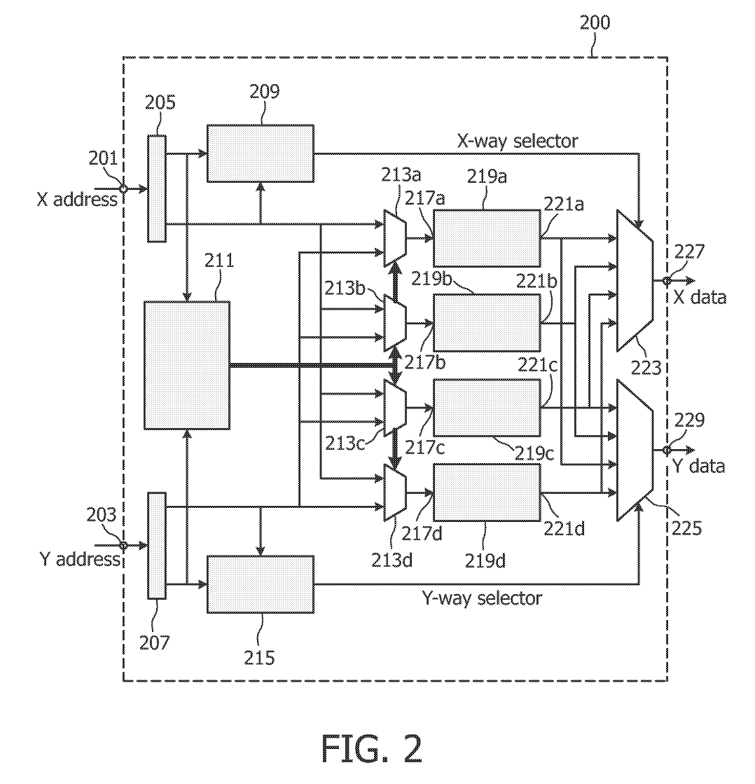

FIG. 2 illustrates a simplified block diagram of a multi-port cache architecture for a DSP according to an embodiment of the present invention.

A preferred embodiment of the present invention will now be described with reference to FIG. 2. The multi-port cache memory 200 is a dual-port (dual-Harvard) architecture. Although a dual-port memory is illustrated here, it can be appreciated that any number of ports may be implemented. For simplicity, the operation of the cache according to the preferred embodiment will be described with reference to cache reads.

The writes may be buffered or queued in other ways.

The present invention may be implemented in all applications containing a (dual-Harvard-based) DSP with cache memory, as is typical for more modern DSP architectures. Examples include cell phones, audio equipment (MP3 players), etc.

The multi-port (dual-port) cache memory 200 of the preferred embodiment of the present invention comprises a first input port 201 and a second input port 203. Each input port 201, 203 is connected to respective address decoders 205, 207.

One output terminal of the first address decoder 205 is connected to an input of a first tag memory 209 and an input of a prediction logic circuit 211. Another output terminal of the first decoder 205 is connected to another input of the first tag memory 209 and first inputs of a plurality of multiplexers 213a, 213b, 213c and 213d.

One output terminal of the second address decoder 207 is connected to an input of a second tag memory 215 and another input terminal of the prediction logic circuit 211. Another output terminal of the second decoder 207 is connected to another input terminal of the second tag memory 215 and second inputs of the plurality of multiplexers 213a, 213b, 213c and 213d.

The output of the prediction logic circuit 211 is connected to each of the plurality of multiplexers 213a, 213b, 213c and 213d. The output of each multiplexer 213a, 213b, 213c and 213d is connected to a respective input port 217a, 217b, 217c and 217d of a plurality of single-ported memory blocks 219a, 219b, 219c and 219d. The output port 221a, 221b, 221c and 221d of each single-ported memory block 219a, 219b, 219c and 219d is connected to respective inputs of a first and second way multiplexers 223, 225.

The output of the first tag memory 209 is connected to the first way multiplexer 223 and the output of the second tag memory 215 is connected to the second way multiplexer 225. The output of the first way multiplexer 223 is connected to a first output port 227 of the cache memory 200. The output of the second way multiplexer 225 is connected to a second output port 229 of the cache memory 200.

Similar to the operation of the prior art cache memory described above with reference to FIG. 1, each address X and Y is placed on first and second input ports 201, 203, respectively. The address is then divided into its tag part (upper bits) and index (lower bits) by its respective decoder 205, 207. The tag part is placed on one output terminal of each decoder and input into the respective tag memories 209, 215. The index of the each address X and Y is also input into the respective tag memories 209, 215. A look up is carried out according to the tag and respective X-, Y-way selectors are output to their respective way multiplexers 223, 225. The tag of each address X and Y is also input into the prediction logic circuit to assist in the next way prediction. Each index of each input address X, Y is placed on respective input of each of a plurality of multiplexers 213a, 213b, 213c, 213d. The output of the prediction logic circuit 211 selects which index to be placed on the output of each of the plurality of multiplexers 213a, 213b, 213c, 213d. The selected index is placed on the respective input ports 217a, 217b, 217c, 217d of each memory block 219a, 219b, 219c, 219d.

The selected index accesses a cache line storage location or way in each memory block 219a, 219b, 219c, 219d which is output from each memory block 219a, 219b, 219c, 219d. The output of each memory block 219a, 219b, 219c, 219d is then selected by the X-, Y-way selectors by the first and second way multiplexers 223, 225 such that the data addressed is output on the first or second output ports 227, 229.

In accordance with the preferred embodiment, the tag memory lookup is carried out in parallel and the output of the lookup, the X- and Y-selectors select the correct output at the end of memory access.

The prediction logic 211 monitors the actual values resulting from the tag memory access, at the end of the access cycle to confirm the correctness of the selection. In the case of a wrong prediction, the wrong address will be sent to a particular memory block, e.g. the memory block containing the Y value would be addressed by the X address. In this case, the memory access must be redone with the correct address as determined from the tag memories (209, 215) instead of the output of the multiplexers 213a, 213b, 213c, 213d in accordance with a conventional cache access.

It can be appreciated that predictions can be done in many ways. In its simplest form merely to predict the next access by assuming the next to be the same as the previous access. Another way would be to keep a history of tag/way pairs and predict the next way by examining trends in the history. This method would have a lower probability of a wrong prediction compared to the previous method. However, maintaining an extensive history would require a memory which would duplicate the tag memory. Therefore, a preferred method would be to maintain a record of the last few accesses in high-speed registers to provide a more accurate high speed prediction, which does not have larger memory resources which would be expensive and slow.

A more elaborate prediction scheme would be, per space, use the last N accesses to predict up to N different ways (e.g. N being equal to the number of DSP address pointers).

ISA and compiler technology can be used to steer way allocation, in order to reduce, or even eliminate way-misprediction. The predictions are thus made more reliable by making sure the tag/way combinations are used in a more structured and predictable way.

Alternatively, the way prediction could be performed by adding intelligence in the cache victim selection algorithm to prevent fragmentation of the way memories. The next predicted cache line is taken to be most likely in the same physical memory block as the current line.

In general, way-locking could be a mechanism to quasi dynamically divide both the X and Y memory spaces into a configurable number of sectors. For each sector, a number of ways can be assigned, and it could be flagged that this section is shared or non-shared over both access ports.

Prediction accuracy can be improved by having more information on the access; e.g. by knowing which pointer of a set of pointers is performing the request. This requires extra information from the processor to be passed to the predictor.

In this way, single-ported memory blocks can be utilized in a multi-port cache.

Although a preferred embodiment of the system of the present invention has been illustrated in the accompanying drawings and described in the foregoing detailed description, it will be understood that the invention is not limited to the embodiment disclosed, but is capable of numerous variations, modifications without departing from the scope of the invention as set out in the following claims.

1. A multi-port cache memory comprising:
a plurality of input ports for inputting a plurality of addresses, at least part of each address indexing a plurality of ways;
a plurality of output ports for outputting data associated with each of said plurality of addresses;
a plurality of memory blocks for storing said plurality of ways, each said memory block comprising a single input port;
a predictor for predicting which plurality of ways will be indexed by each of said plurality of addresses;
means for indexing said plurality of ways based on the predicted ways; and
means for selecting one of said plurality of ways such that data of said selected way is output on an associated output port of said cache memory.

2. A multi-port cache memory according to claim 1 wherein the selecting means comprises a plurality of tag memories for looking up a tag part of each associated address in parallel to indexing of said plurality of ways.

3. A multi-port cache memory according to claim 1 wherein the predictor compares the tag part of the address with that of the previous address to predict the ways.

4. A multi-port cache memory according to claim 1, wherein the predictor maintains a history of the last n accesses and examines trends in the history to predict the next way.

5. A multi-port cache memory according to claim 1, wherein the predictor, per space, uses the last N accesses to predict up to N different ways.

6. A multi-port cache memory according to claim 5, wherein N is equal to the number of address pointers.

7. A multi-port cache memory according to claim 1, wherein the predictor further includes means for establishing which address pointer within a set of address pointers is performing the request and predicting the next way on the basis of which address pointer is performing the request.

8. A digital signal processor including a multi-port cache memory according to claim 1.

9. A digital signal processor according to claim 8, wherein the multi-port cache is a dual-ported cache for dual-Harvard architecture.

10. A digital signal processor according to claim 9, wherein the predictor tracks only dual accesses.

11. A mobile telephone device including a digital signal processor according to any one of claims 8.

12. An electronic handheld information device including a digital signal processor according to any one of claims 8.
